(19) United States
(12) Patent Application Publication
(10) Pub. No.: US 2003/0196867 A1
(43) Pub. Date: Oct. 23, 2003

(54) Park interlock device

(76) Inventors: Michael Jeffrey Lowry, Indianapolis, IN (US); John Derek Williams, New Palestine, IN (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 10/128,543

(22) Filed: Apr. 23, 2002

(51) Int. Cl. B60K 41/26

(52) U.S. Cl. 192/219

(57) ABSTRACT

A park interlock device for a land-based vehicle including a driver-selectable shifter for selecting a respective one of the propulsion modes of the vehicle is provided. The device includes a generally elongated, hollowed body. The device further includes an actuating rod configured to be axially disposed in said hollowed body. The actuating rod is responsive to increments in linear motion produced when the shifter is set to a new propulsion mode. A detent assembly is configured to securely engage into a respective one of a plurality of notches in correspondence with a selected propulsion mode of the vehicle. A plunger is disposed at one end of the actuating rod. The plunger is mechanically biased and is responsive to axial movement of the actuating rod due to the linear motion produced when the shifter is set to a new propulsion mode to selectively reach a desired interlocking state for every propulsion mode of the vehicle without performing any conversion from linear to rotational motion in the park interlock device.

### BACKGROUND OF THE INVENTION

The present invention is generally related to electromechanical devices for vehicular applications, and, more particularly is related to a park interlock device for land-based vehicles.

Presently prescribed governmental regulations and/or standards, such as the Federal Motor Vehicle Safety Standards, (FMVSS) require the installation of a parking interlock device to mechanically lock the wheels of a vehicle when parked. Typically, this is accomplished by locking the output shaft of the transmission, thus preventing the vehicle wheels from rotating when the shift selector is placed in the ‘Park’ position. One of the purposes of this device is to prevent the vehicle from rolling when parked on a surface with a gradient, i.e., a surface with a slope or inclination. This requirement also applies to electric or hybrid electric vehicles, such as may be equipped with an Integrated Starter/Generator (ISG) system. Thus, an interlock park device would be needed as part of the electric power train regardless of whether or not the vehicle is equipped with an automatic transmission. The FMVSS further prescribes operational conditions that the device must perform. Examples of these conditions include: “Ratchet”, Hill-hold (tooth abutment condition), and vehicle roll to prescribed lock-up limits. Various values of surface gradients and limiting speeds are prescribed in the FMVSS, and the device must comply with such standards, or any other applicable standards.

In known implementations, the interlock device is generally responsive to a shift selector lever that includes Park, Reverse, Neutral, and at least one forward Drive position. The shift lever includes a cable connected to a pawl lever anchored by a pivot pin connected to the transmission housing. The pawl lever is mounted to a shaft that in turn is hard-mounted to a detent plate. The shaft projects through the transmission housing and engages a switch assembly that registers the position of the shift lever selector. The detent plate generally engages a spring inside the transmission that prevents the detent plate and shaft from rotating to maintain the appropriate switch position, even in the presence of shock, and/or vibration in the vehicle. A toothed pawl gear is mounted on the output shaft of the transmission, and a spring-loaded toggle or plunger, supported by the detent plate, provides an engagement force with the pawl gear to mechanically lock the output shaft connected to the driven wheels of the vehicle. In operation, when the shift selector is rotated to a new position, the cable extends (or retracts) in length and this movement causes the pawl lever and associated components to rotate and actuate the switch assembly and register the new shift lever position and provide this new position indication to a transmission controller. The detent plate upon being rotated to the new position is held in position by the spring in the transmission.

Thus, known park interlocking devices are commonly actuated by a mechanical linkage that converts linear travel of the cable to rotational travel of the switch assembly to eventually cause engagement of the plunger assembly to the appropriate position. That is, engagement to either the locked position or the unlocked position depending on the position of the shift lever. As should be appreciated from the assemblage of the numerous components illustrated in FIG. 1 for one known park interlock device, such devices generally require a large number of components to accomplish the linear-to-rotational travel for locking or unlocking the output shaft connected to the wheels of the vehicle.

Although known park interlocking devices provide generally reliable operation, such devices have presented challenges in systematically managing the required shift effort, linkage tolerances, and providing fault detection as to faults that may develop in the interlocking device. For example, the mechanical linkage between the interlocking device and the shift selector may result in mismatched detent combs, misalignment of the park interlock position and inadequate engagement loads to the park interlock to quickly achieve the appropriate locking functionality. This could ultimately result in inadequate Hill-hold engagement performance (e.g., the vehicle may roll down hill faster than the park interlock can engage) and/or high “ratchet-down” engagement speed (e.g., if the shift selector is placed in Park while the vehicle is moving above some relatively low speed, e.g., approximately 5.0 mph, the interlock device might engage, and could result in exposing the occupants to undue forces, equipment damage, or both).

In view of the foregoing issues, it would be desirable to provide an improved park interlock device, such as a unitized and compact assembly that advantageously replaces the multiple components required by known devices, and uses the travel of the shift cable to directly provide linear motion to the plunger assembly, unlike known park lock devices which convert the cable travel to rotational travel to eventually actuate the plunger assembly. It would be further desirable to provide a park interlock device that is manufacturable at lower cost, and is structurally and functionally simpler than known park interlock devices while maintaining existing interfaces with other sub-systems in the vehicle. It would be also desirable to provide a park interlock device that may be used for electric/hybrid electric and ISG propulsion systems, to economically and reliably provide on demand “Hill-hold” functionality using “interlock-by-wire”, i.e., electronically-based, control techniques and device responsive to electrical signals from a controller. That is, a park interlock device capable of being electronically controlled by the electric/hybrid or ISG controller. Additionally, it would be desirable to integrate within the park interlock device inexpensive sensors for detecting malfunctions that may occur while operating the device.

### BRIEF SUMMARY OF THE INVENTION

Generally, the present invention fulfills the foregoing needs by providing in one aspect thereof a park interlock device for a land-based vehicle. The device comprises a generally elongated, hollowed body, e.g., cylindrical body. An actuating rod is configured to be axially disposed in the cylindrical body. The actuating rod includes a plurality of notches indicative of a respective propulsion mode of the vehicle, and one of the propulsion modes comprises a park mode. A detent assembly is configured to securely engage into a respective one of the plurality of notches in correspondence with a selected propulsion mode of the vehicle. A plunger is disposed at one end of the actuating rod. The plunger is mechanically biased and is responsive to axial movement of the actuating rod in the cylindrical body to selectively reach a desired interlocking state for every propulsion mode of the vehicle.

In another aspect of the present invention, the interlock device is responsive to a controller including a driver-selectable shifter for selecting a respective one of the propulsion modes of the vehicle. The controller is responsive to at least one sensor for sensing at least one vehicle parameter for determining whether or not the park interlock device is to be actuated to a respective interlock state. The controller includes memory configured to store a plurality of park interlock logical rules for determining whether or not the park interlock device should be actuated to a respective interlocking state based on the respective propulsion mode selected by the driver and/or as determined by the controller while stopping and starting the vehicle in accordance with prescribed vehicle regulations. The memory is further configured to store nominal values for the vehicle parameters. A comparator is configured to compare each sensed vehicle parameter relative to the values stored in memory so that based on the results of the comparison, a control signal for commanding the interlock device to the respective interlock state is generated by the controller.

The present invention further fulfils the foregoing needs by providing a park interlock device for a land-based vehicle including a driver-selectable shifter for selecting a respective one of the propulsion modes of the vehicle. The device includes a generally elongated, hollowed body. The device further includes an actuating rod configured to be axially disposed in said hollowed body. The actuating rod is responsive to increments in linear motion produced when the shifter is set to a new propulsion mode. A detent assembly is configured to securely engage into a respective one of a plurality of notches in correspondence with a selected propulsion mode of the vehicle. A plunger is disposed at one end of the actuating rod. The plunger is mechanically biased and is responsive to axial movement of the actuating rod due to the linear motion produced when the shifter is set to a new propulsion mode to selectively reach a desired interlocking state for every propulsion mode of the vehicle without performing any conversion from linear to rotational motion in the park interlock device.

### BRIEF DESCRIPTION OF THE DRAWINGS

The features and advantages of the present invention will become apparent from the following detailed description of the invention when read with the accompanying drawings in which:

FIG. 1 illustrates an assemblage of various components for one known park interlock device that requires linear to rotational motion conversion.

FIG. 2 in part illustrates a cross-sectional view of an exemplary embodiment of a park interlock device that, in accordance with aspects of the present invention, can directly provide linear motion to a plunger locking mechanism.

FIG. 3 illustrates an exemplary schematic representation of a control system including a controller for electronically controlling a park-interlock device in a land-based vehicle.

FIG. 4 illustrates another exemplary embodiment of the park interlock device including a separate pawl for engaging and locking a park lock ring.

### DETAILED DESCRIPTION OF THE INVENTION

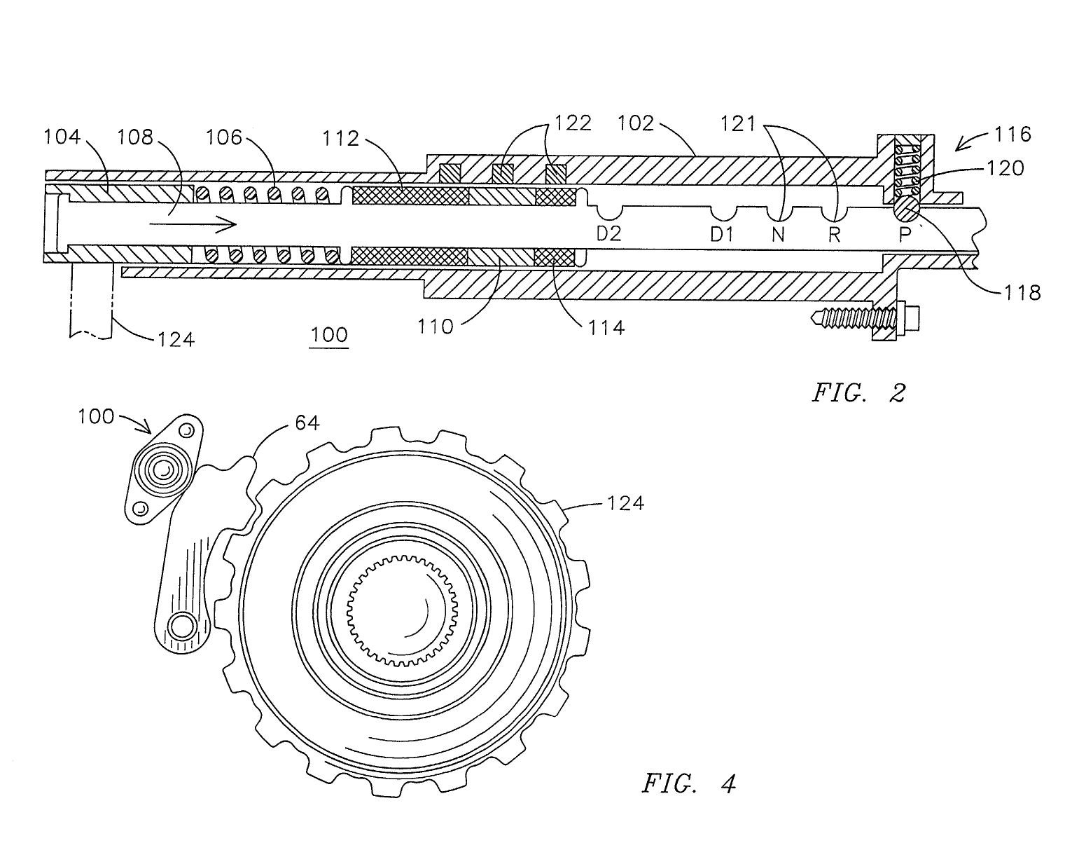

FIG. 2 illustrates an exemplary embodiment of a park interlock device 100 that, in accordance with aspects of the present invention, can directly provide linear motion to a plunger assembly, unlike known park lock devices that convert cable travel to rotational travel to eventually actuate the plunger assembly. In one exemplary embodiment, park interlock device 100 comprises a generally elongated, hollowed body 102, e.g., an integral cylindrical body that compactly accommodates the relatively few components assembled therein to provide actuation of the plunger assembly in response to either a mechanical input, such as may be provided by the shift cable, or as may be provided by an electromechanical actuator, in the event of a “fly-by-wire” implementation.

As shown in FIG. 2, park interlock device 100 includes a pawl plunger 104 mechanically biased by a compression spring 106. An actuating rod 108 extends axially along a bore defined by the cylindrical body 102. A non-magnetic ring 110, e.g., made of steel or any other suitable non-magnetic material, is interposed between two magnet segments 112 and 114. Park interlock device 100 further includes a detent assembly 116, e.g., a ball detent 118 respectively biased by a spring 120 for engagement into a respective one of a plurality of notches or slots 121 corresponding to a respective position of the shift lever. A plurality of sensors, e.g., sensors 122_{A}, 122_{B}, and 122_{C} is integrated into the device body for providing park interlock device status to a suitable vehicle controller. In one exemplary embodiment, the plurality of sensors is made up of three Hall-effect sensors having a predefined arrangement relative to the magnet segments 112 and 114 at each end of ring 110 to determine the position of the actuating rod. It will be appreciated by those skilled in the art that other types of position sensors and arrangements, e.g., magneto-resistive sensors, capacitive sensors, etc., may be used for determining whether the actuating rod has failed to extend or retract into a position corresponding to the shift lever position. For example, although the sensors are exemplarily illustrated as embedded in the device body, it will be appreciated that the sensors could be embedded in the actuating rod and the ring and magnet segments could be arranged on the inner surface of the device body.

In one exemplary embodiment, the pawl plunger would be driven to engage a park lock ring 124 to lock it in rotation. As suggested above, pawl plunger 104 is spring-loaded by spring 106 relative to actuating rod 108 so that when the rod is driven to the park position the pawl may be retracted if the pawl plunger happens to be indexed inline with park lock ring 124. When the vehicle wheels rotate, the ring will rotate so that the pawl gear is eventually inline with a gap in the ring and the pawl will extend to lock the park lock ring. In one exemplary embodiment, the actuating rod may be attached to the vehicle shift selector lever cable and is extendable and retractable in response to movement of that cable.

In one exemplary embodiment, operation of the linear park interlock device may be as follows. In FIG. 2, exemplary selectable positions for the propulsion of the vehicle, such as Park, reverse, neutral, and two drive positions are illustrated. For example, in the Park position, pawl plunger 104 would be engaged with the park lock ring and spring 106 would be fully extended. Ball detent 118 would engage the notch labeled with the letter P in the actuating rod to secure the rod in the park position. Sensors 122_{A} and 122_{C} would each be positioned over a corresponding magnet segment and therefore each would supply a logic one signal. As illustrated in table 1 below, the logic combination of the three sensors in the park position may be 101. As suggested above, with the rod in the same position, a tooth-abutment condition can occur when the pawl gear is in inline with a park lock ring.

In the non-park positions, the pawl plunger would be disengaged from the park lock ring. For example, in Reverse, sensors 122_{A} and 122_{B} is each positioned over a respective magnet segment and therefore each would supply a logic one signal. As shown in Table 1, the logic combination of the three sensors in the reverse position is 110. In neutral, sensors 122_{B} and 122_{C} is each positioned over a magnet segment so the logic combination is 011. For the two drive positions the logic combination is 001, and 000, respectively. It will be appreciated that the logic combinations illustrated in Table 1 represent one example and should not be construed as a limitation since many other logic combinations for sensing the respective vehicle propulsion positions could be implemented.

SENSOR LOGIC (HIGH = 1)

| POSITION | A | B | C |
|---|---|---|---|
| Park | 1 | 0 | 1 |
| Reverse | 1 | 1 | 0 |
| Neutral | 0 | 1 | 1 |
| Drive 1 | 0 | 0 | 1 |
| Drive 2 | 0 | 0 | 0 |

Those skilled in the art will understand that the linear interlock device in accordance with aspects of the present invention may be provided in various configurations. For example, one alternate technique for configuring the pawl plunger to lock the park gear is for the plunger and pawl to be separate components in lieu of an integrated assembly. As illustrated in FIG. 4, in this embodiment, the plunger in device 100 would engage the separate pawl 64 during Park causing the pawl to engage and lock the park lock ring 124. The alternate device with the separate park pawl would operate as follows: The park pawl plunger, in this device, would include a straight section and a conical section that transitions to a larger diameter. In the non-park positions, the smaller diameter straight section is positioned over the pawl. The pawl may be a spring loaded by a suitable spring, e.g., a torsion spring, and is forced against the straight section with the smaller diameter. In the park position, the plunger is extended sufficiently far so that its larger diameter section is positioned over the pawl. The plunger forces the pawl inward so that it engages the park lock ring. If the park lock ring happens to be aligned so that the pawl tooth is in line with the ring tooth, the spring loaded plunger will not fully extend. When the ring rotates, as it will occur when the vehicle momentarily rolls, the spring will force the plunger to extend causing the pawl to rotate into an opening in the park lock ring.

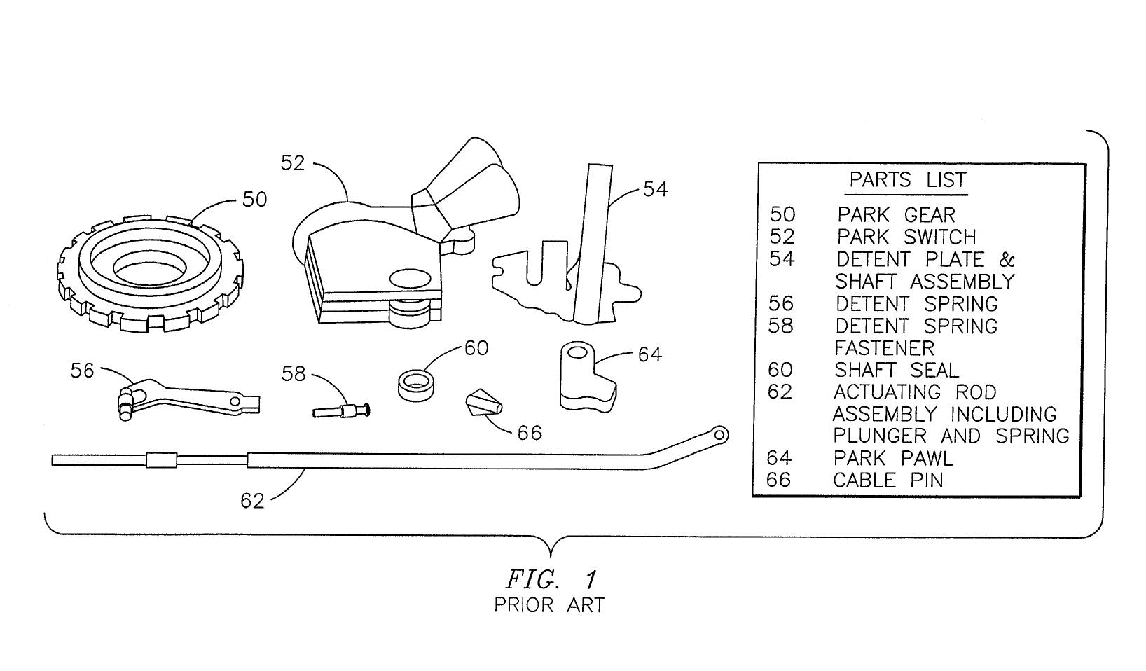

It will be appreciated that the linear park interlock device in accordance with aspects of the present invention allows simplifying the multiple components of prior interlock devices (see FIG. 1) into an integrated assembly and directly translates the linear motion of the shift cable into linear motion of the park actuator rather than the more complex present technique of translating the linear cable motion into rotation of a shaft and then linear translation of the park actuator. The inventors of the present invention have innovatively provided an interlock device that is simpler, smaller, and producible at lower cost than known park interlock devices. Interlock devices using the parts shown in FIG. 1 generally provide good quality, and reliable, operation. However, a comparison of FIGS. 1 and 2 quickly reveals the great cost advantage (in terms of both cost and assembly labor or time) associated with producing a linear interlock device in accordance with aspects of the present invention. This comparison also should emphasize the significance of the process and product innovations presented herein which result in products of such quality, reliability, and performance, that they should be expected to replace interlock devices comprised of the prior parts shown in FIG. 1.

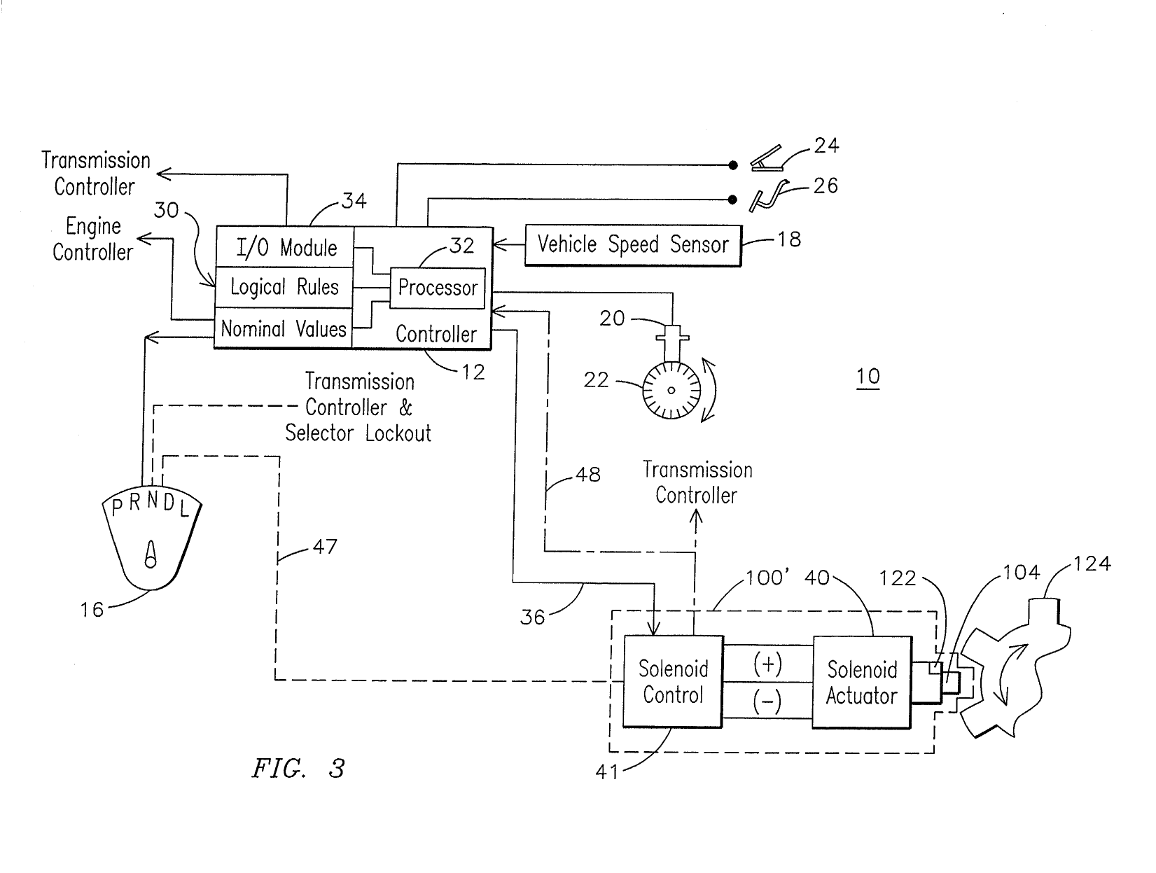

FIG. 3 illustrates a schematic representation of a control system 10 including a controller 12 for electronically controlling park-interlock device 100 in a land-based vehicle, such as an electric or hybrid electric vehicle that may be equipped with an Integrated Starter Generator (ISG) subsystem, part of its propulsion drive system. For readers who desire further information regarding innovative techniques for controlling a park-interlock device in a land-based vehicle with a driver-selectable shifter for selecting a plurality of propulsion modes of the vehicle, reference is made to U.S. application Ser. No. 09/965,183 filed Sep. 27, 2001, commonly assigned to the assignee of the present invention, and herein incorporated by reference.

FIG. 3 illustrates a driver-selectable shifter 16 for selecting a respective one of a plurality of propulsion modes of the vehicle, such as Park, Reverse, Neutral, and at least one forward Drive mode. In accordance with aspects of the invention, at least one sensor is provided for sensing at least one vehicle parameter for determining whether or not park interlock device 100 is to be actuated to a respective interlock state corresponding to the driver-selected mode. The actuation of the park-interlock device to the respective interlocking state may be further based on an operational mode determined by the controller. One example of the operational mode determined by the controller may comprise a stop/start mode, as may be implemented during a Hill-hold mode of operation of the vehicle. Examples of the vehicle parameters include: vehicle speed, such as may be sensed with a standard vehicle speed sensor 18, e.g., a tachometer or equivalent; engine speed, such as may be sensed with a standard engine speed sensor 20, such as a Hall, or magneto-resistive sensor that may be electromagnetically excited by a target wheel 22, or a standard crank sensor or equivalent, using techniques well-understood by those skilled in the art; throttle command, such as may be sensed by sensing position of a throttle pedal 24 or equivalent; braking state, such as may be sensed by sensing position of a brake pedal 26 or equivalent; and the propulsion mode selected by the driver such as may be sensed by sensing the position selected by the driver on the shift selector.

As shown in FIG. 3, controller 12 includes a memory 30 for storing a plurality of park interlock logical rules for determining whether or not or not park interlock device 100 should be actuated to a respective interlocking state based, at least in part, on the respective propulsion mode selected by the driver. As suggested above, the interlocking state may be further based on the appropriate stop/start operational mode of the vehicle for implementing the Hill-hold function. The controller automatically determines the operational stop/start mode. The memory 30 may further be used for storing a set of nominal values for the vehicle parameters. The nominal values may be experimentally and/or analytically derived for a given application or may be based on any applicable prescribed standards for the given application. A processor 32 is configured to process the park interlock rules stored in memory 30 using at least one vehicle parameter supplied through a suitable input/output module 34 so that based on the actual values of each vehicle parameter relative to the nominal set of vehicle parameter values, a control signal 36 for commanding the interlock device to the appropriate interlock state is generated. For example, a solenoid 40 responsive to a suitable solenoid drive circuit 41 may be used to extend or retract the pawl plunger from one of the gaps in the locking ring 124, as determined by controller 12. In one exemplary embodiment, the controller 12 may be the same controller that provides the control for the ISG subsystem. It will be understood, however, that controller 12 may be a stand-alone controller or incorporated into other controllers that may be used by the propulsion system, such as the engine controller in a hybrid electric vehicle, or electric machine controller in an electric vehicle, or a transmission controller in a vehicle so equipped.

In one exemplary embodiment control system 10 is built with backup redundancies to ensure reliable operation and graceful degradation in the presence of malfunctions. For example, as conceptually represented by dashed line 47, in the event a malfunction were to develop in the controller 12, the interlock device control would be delegated to be based on the position of the gear selector. For example, if the gear selector were set to Park, then the interlock device would be commanded to the locking state, as would be the case in a standard park interlock application. Further, as suggested above, dashed line 48 conceptually represents plunger position information that may be supplied to the controller 12 so that an appropriate warning message or indication may be displayed to the driver, or in some applications, the operation of the propulsion system may be gracefully degraded to allow the driver to reach a service shop for appropriate servicing or repair.

Aspects of the present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A park interlock device for a land-based vehicle, the device comprising:
a generally cylindrical body;
an actuating rod configured to be axially disposed in said cylindrical body, the actuating rod including a plurality of notches indicative of a respective propulsion mode of the vehicle, one of the propulsion modes comprising a park mode;
a detent assembly configured to securely engage into a respective one of the plurality of notches in correspondence with a selected propulsion mode of the vehicle; and
a plunger disposed at one end of the actuating rod, the plunger being mechanically biased and responsive to axial movement of the actuating rod in the cylindrical body to selectively reach a desired interlocking state for every propulsion mode of the vehicle.

2. The interlock device of claim 1 further comprising one or more sensors coupled to provide respective signals indicative of status of the park interlock device.

3. The interlock device of claim 1 wherein the detent assembly comprises a detent ball radially urged by a spring into the respective one of the plurality of notches in correspondence with a selected propulsion mode of the vehicle.

4. The interlock device of claim 2 further comprising a non-magnetic ring interposed between at least two magnet segments.

5. The interlock device of claim 2 wherein the sensors for providing park interlock device status are embedded in the body of the interlock device and the non-magnetic ring interposed between the at least two magnet segments is each arranged along the actuating rod.

6. The interlock device of claim 2 wherein the sensors for providing park interlock device status are embedded in the actuating rod and the non-magnetic ring interposed between the at least two magnet segments is each arranged on an inner surface of the interlock device.

7. The interlock device of claim 1 in combination with and responsive to a controller coupled to a driver-selectable shifter for selecting a respective one of the propulsion modes of the vehicle, the controller being responsive to at least one sensor for sensing at least one vehicle parameter for determining whether or not the park interlock device is to be actuated to a respective interlock state, the controller comprising:
memory configured to store a plurality of park interlock logical rules for determining whether or not the park interlock device should be actuated to a respective interlocking state based on the respective propulsion mode selected by the driver and/or as determined by the controller while stopping and starting the vehicle in accordance with prescribed vehicle regulations, the memory further configured to store nominal values for the vehicle parameters; and
a comparator configured to compare each sensed vehicle parameter relative to the values stored in memory so that based on the results of the comparison, a control signal for commanding the interlock device to the respective interlock state is generated by the controller.

8. A park interlock system for a land-based vehicle having, the system including a park interlock device comprising:
a generally elongated, hollowed body;
an actuating rod configured to be axially disposed in said hollowed body, the actuating rod including a plurality of notches indicative of a respective propulsion mode of the vehicle, one of the propulsion modes comprising a park mode;
a detent assembly configured to securely engage into a respective one of the plurality of notches in correspondence with a selected propulsion mode of the vehicle;
a plunger disposed at one end of the actuating rod, the plunger being mechanically biased and responsive to axial movement of the actuating rod in the device body to selectively reach a desired interlocking state for every propulsion mode of the vehicle;
the system further including a controller coupled to a driver-selectable shifter for selecting a respective one of the propulsion modes of the vehicle, the controller being responsive to at least one sensor for sensing at least one vehicle parameter for determining whether or not the park interlock device is to be actuated to a respective interlock state, the controller comprising:
memory configured to store a plurality of park interlock logical rules for determining whether or not the park interlock device should be actuated to a respective interlocking state based on the respective propulsion mode selected by the driver and/or as determined by the controller while stopping and starting the vehicle in accordance with prescribed vehicle regulations, the memory further configured to store nominal values for the vehicle parameters; and
a comparator configured to compare each sensed vehicle parameter relative to the values stored in memory so that based on the results of the comparison, a control signal for commanding the interlock device to the respective interlock state is generated by the controller.

9. A park interlock device for a land-based vehicle including a driver-selectable shifter for selecting a respective one of the propulsion modes of the vehicle, the device comprising:
a generally elongated, hollowed body;
an actuating rod configured to be axially disposed in said hollowed body, the actuating rod being responsive to increments in linear motion produced when the shifter is set to a new propulsion mode;
a detent assembly configured to securely engage into a respective one of a plurality of notches in correspondence with a selected propulsion mode of the vehicle;
a plunger disposed at one end of the actuating rod, the plunger being mechanically biased and responsive to axial movement of the actuating rod due to the linear motion produced when the shifter is set to a new propulsion mode to selectively reach a desired interlocking state for every propulsion mode of the vehicle without performing any conversion from linear to rotational motion in the park interlock device.
